(19) United States
(12) Patent Application Publication
(10) Pub. No.: US 2004/0114365 A1
(43) Pub. Date: Jun. 17, 2004

(54) Light source spotlight device of a scan device

(75) Inventors: Po-Hua Fang, Yung-Ho City (TW); Shu-Ya Chiang, Taichung City (TW)

Correspondence Address: LOWE HAUPTMAN GILMAN & BERNER, LLP, Suite 310, 1700 Diagonal Road, Alexandria, VA, 22314, US

(73) Assignee: VEUTRON CORPORATION

(21) Appl. No.: 10/319,640

(22) Filed: Dec. 16, 2002

(51) Int. Cl. F21V 13/04

(52) U.S. Cl. 362/245; 362/247

(57) ABSTRACT

The present invention relates to a spotlighted device, more particularly, to a light source spotlighted device using in a scan device to make light condense in the first axial of a scanning plate and disperse uniformly in the second axial of the scanning plate, wherein the first axial and the second axial are perpendicular to one another. When light passing through the light source spotlighted device of the present invention to form a banding shining area on the scanning plate, a length of the banding shining area in the first axial will be reduced and the light which is distributed in the second axial will become more uniformly to avoid a dim area defect in a scanning process and to increase qualities of scanning image.

### BACKGROUND OF THE INVENTION

1. Field of the Invention

The present invention relates to a spotlighted device, more particularly, to a light source spotlighted device using in a scan device to avoid a dim area defect in a scanning process and to increase qualities of scanning image.

2. Description of the Prior Art

For present information users, especially to the personal computer users, a mode of the computer information has been changed from an unexciting word mode to a multi-media mode. The multi-media mode means that the information comprises words, images, and sounds. In order to show the multi-media mode in the face of viewers, various multi-media devices, which can collect the images and sounds, are developed. Because the multi-media information comprises more matters, memories, which are used to deal with the multi-media information, are greater than memories, which are used to deal with the unexciting word information to show the multi-media information more smoothly.

For an input image device, scanners and digital cameras are the common devices at the present day. The digital camera uses digital information to save the image, which is got from shooting a scene on a location. It uses a floppy disk card or a personal computer memory card international association (PCMCIA) card to save a static image. In order to decrease the memory of saving multi-media information, the images, which are got from shooting a scene on a location by using a digital camera, are saved by using compression files. The file format of a joint photographic experts group (JPEG) mode is common used in the static image compression files.

Referring to FIG. 1, this shows a diagram of a traditional light source spotlighted device. In the traditional scanning device, a bar shape light source, such as: a fluorescent lamp, cold cathode fluorescent lamp (CCFL) and so on, is usually used to be a light source 10 of the traditional scanning device. The light source 10 is assembled on the light assembly 15 of the scanning device and a condensing cover 20 is assembled on the light source 10 of the light assembly 15 to provide sufficient light in the scanning process. The light assembly 15 can move along the first axial X of the scanning plate and a length of the light source 10 in the second axial Y is almost equal to a length of the light assembly 15 in the second axial Y, wherein the first axial X and the second axial Y are perpendicular to one another.

The traditional CCFL light source has problems, such as: a short lifetime, a long warm-up time for obtaining a steady light and so on. Therefore, a plurality of light emitting diodes (LEDs) is used to replace the bar shape light source at present to solve the aforementioned problems successfully, wherein the characteristics of the LED are a long lifetime and rapidly reaching a lighting steady state. A plurality of the LEDs is assembled in a line for providing a bar shape light, where there is a gap between any two of the LEDs. Because of the gaps, when light passes through the condensing cover to form a banding shining area on the scanning plate, the light which disperses at the banding shining area are non-uniform to bring the dim area defect if the traditional condensing cover which is produced by using transparent material is only used. The dim area defect will affect the qualities of the scanning image.

### SUMMARY OF THE INVENTION

In accordance with the background of the above-mentioned invention, using the plurality of block luminous bodies to be the light source and the traditional spotlighted structure will form the banding shining area which comprises the dim area defect on the scanning plate to affect the qualities of the scanning image. The present invention provides a light source spotlighted device using in the scan device to increase qualities of scanning image by using the light source spotlighted device, which comprises lens components, of the present invention.

The second objective of the present invention is to condense light in the first axial of the scanning plate by using the light source spotlighted device, which comprises lens components, of the present invention.

The third objective of the present invention is to disperse light uniformly in the second axial of the scanning plate by using the light source spotlighted device, which comprises lens components, of the present invention.

The fourth objective of the present invention is to avoid dim area defect appearing at the banding shining area, which is on the scanning plate, by using the light source spotlighted device, which comprises lens components, of the present invention.

The fifth objective of the present invention is to increase brightness of the banding shining area on the scanning plate by using the light source spotlighted device, which comprises lens components, of the present invention.

The further objective of the present invention is to increase the uniform level of the banding shining area on the scanning plate by using the light source spotlighted device, which comprises lens components, of the present invention.

In according to the foregoing objectives, the present invention provides a light source spotlighted device using in the scan device to increase qualities of scanning image by using the light source spotlighted device, which comprises lens components, of the present invention. At first, the present invention provides a light assembly, wherein the light assembly can move along the first axial of a scanning plate. A plurality of block luminous bodies, such as: light emitting diode, is arranged along the second axial of the scanning plate on the base of the light assembly, wherein the first axial and the second axial are perpendicular to one another. There is a gap between any two of the block luminous bodies and a length of the gap is decided following needs of processes and products. There are three embodiments of the present invention but a scope of the present invention is not limited. In the first embodiment of the present invention, a condensing cover is divided into the first dispersing structure and the second condensing structure. The first dispersing structure is a part of the dispersing cover that is nearer to the base of the light assembly and comprises a plural of concave lenses, wherein each concave lens is corresponding to each block luminous body and is in the third axial of each block luminous body. A material of the condensing cover is a transparent material and a top of the inside second condensing structure comprises a plural of convex lenses. Each convex lens is in the third axial of each block luminous body, wherein the third axial is vertical to the first axial and the second axial. When the plurality of block luminous bodies shoots light, the light will be dispersed uniformly in the second axial by using the concave lenses of the first dispersing structure and will be condensed along the first axial by using the convex lenses of the second condensing structure to form a banding shining area, whose brightness is more uniform and have no dim area defect, on the scanning plate. In the second embodiment of the present invention, a condensing cover is assembled on the base of the light assembly at first, wherein a material of the condensing cover is a transparent material and comprises the first sidewall and the second sidewall. The first sidewall of the condensing cover comprises a concave mirror and the second sidewall of the condensing cover comprises a convex mirror. When the plurality of block luminous bodies shoots light, the light will be condensed in the first axial by using a reflex of the concave mirror and then the light is reflexed from the concave mirror to the convex mirror to be disperse uniformly in the second axial. The light will be projected on the scanning plate to form a banding shining area, whose brightness is more uniform and have no dim area defect, by reflexing of the concave mirror and the convex mirror. In the third embodiment of the present invention, a condensing cover is assembled on the base of the light assembly at first, wherein a material of the condensing cover is a transparent material and comprises the first sidewall and the second sidewall. The first sidewall of the condensing cover comprises a concave mirror and the second sidewall of the condensing cover comprises a concave lens. When the plurality of block luminous bodies shoots light, the light will be condensed in the first axial by using a reflex of the concave mirror and then the light is reflexed from the concave mirror to the concave lens to be disperse uniformly in the second axial. The light will be projected on the scanning plate to form a banding shining area, whose brightness is more uniform and have no dim area defect, by reflexing of the concave mirror and refracting of the concave lens. The light source spotlighted device of the present invention can also increase the brightness of the banding shining area of the scanning plate and increase the light uniform level of the banding shining area of the scanning plate.

### BRIEF DESCRIPTION OF THE DRAWINGS

In the accompanying drawing forming a material part of this description, there is shown:

FIG. 1 shows a diagram of a traditional light source spotlighted device;

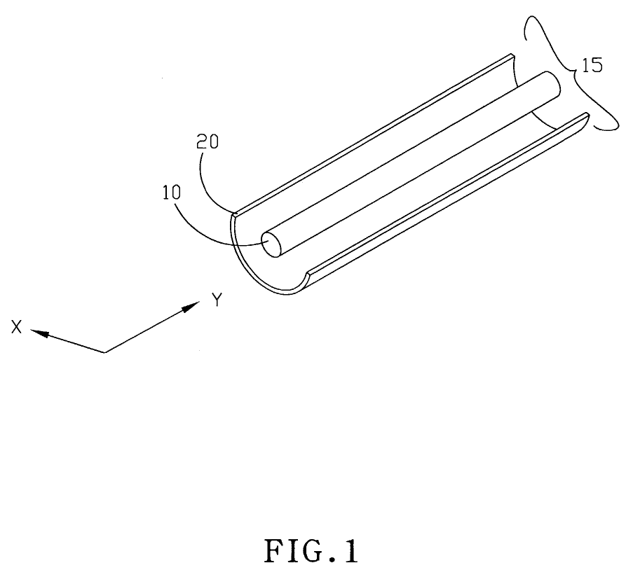

FIG. 2 shows a diagram of the first embodiment of the light source spotlighted device of the present invention;

FIG. 3A shows a diagram of the second embodiment of the light source spotlighted device of the present invention;

FIG. 3B shows a lateral view diagram of the second embodiment of the light source spotlighted device of the present invention;

FIG. 4A shows a diagram of the third embodiment of the light source spotlighted device of the present invention; and

FIG. 4B shows a lateral view diagram of the third embodiment of the light source spotlighted device of the present invention.

### DESCRIPTION OF THE PREFERRED EMBODIMENT

The foregoing aspects and many of the intended advantages of this invention will become more readily appreciated as the same becomes better understood by reference to the following detailed description, when taken in conjunction with the accompanying drawings, wherein:

The present invention provides a light source spotlighted device using in the scan device to increase qualities of scanning image by using the light source spotlighted device, which comprises lens components, of the present invention. Following description is the first embodiment of the present invention and a scope of the present invention is not limited.

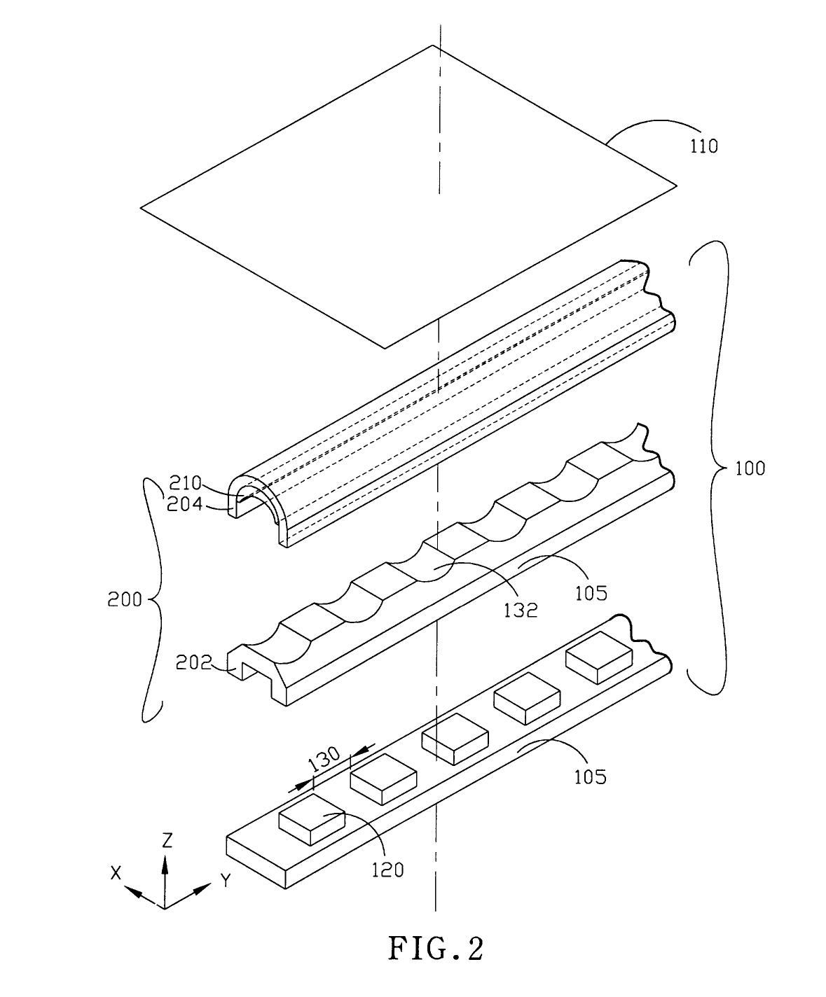

Referring to FIG. 2, this shows a diagram of the first embodiment of the light source spotlighted device of the present invention. At first, the present invention provides a light assembly 100, wherein the light assembly 100 can move along the first axial X of a scanning plate 110. A plurality of block luminous bodies 120, such as: light emitting diode (LED), is arranged along the second axial Y of the scanning plate 110 on the base 105 of the light assembly 100, wherein the first axial X and the second axial Y are perpendicular to one anotherand there is a gap 130 between any two of the block luminous bodies. Then a condensing cover 200 is assembled on the base 105 of the light assembly 100, wherein a material of the condensing cover 200 is a transparent material and the condensing cover 200 comprises the first dispersing structure 202 and the second condensing structure 204. The first dispersing structure 202 is a part of the condensing cover that is nearer to the base 105 of the light assembly and comprises a plural of concave lenses 132, wherein each concave lens 132 is corresponding to each block luminous body 120 and is in the third axial Z of each block luminous body 120. A top of the inside second condensing structure 204 comprises a plural of convex lenses 210 and each convex lens 210 is in the third axial Z of each block luminous body 120, wherein the third axial Z is vertical to the first axial X and the second axial Y.

When the plurality of block luminous bodies 120 is drove to shoot light, the light will be dispensed in the second axial Y by using the concave lenses 132 of the first dispersing structure 202 and the light will be condensed uniformly along the first axial X by using the convex lenses 210 of the second condensing structure 204 to form a banding shining area on the scanning plate 110, wherein the banding shining area will be moved on the scanning plate 110 following the light assembly 100. Because the light is dispersed uniformly in the second axial Y by using the concave lenses 132, the brightness of the banding shining area showing on the scanning plate 110 in the second axial Y will become more uniform and have no dim area defect. Because the light is condensed by the convex lenses 210 in the first axial X, a length of the banding shining area showing on the scanning plate 110 in the first axial X will become shorter and the brightness of the banding shining area will become brighter than in the second axial Y to increase the qualities of scanning image.

Following description is the second embodiment of the present invention and a scope of the present invention is not limited.

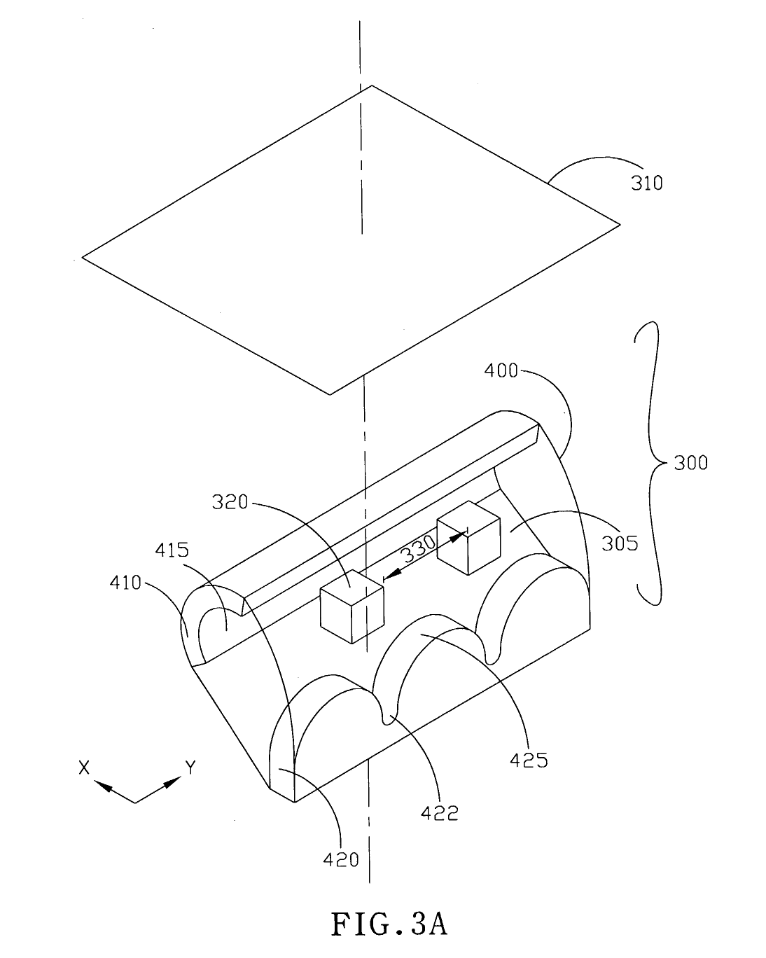

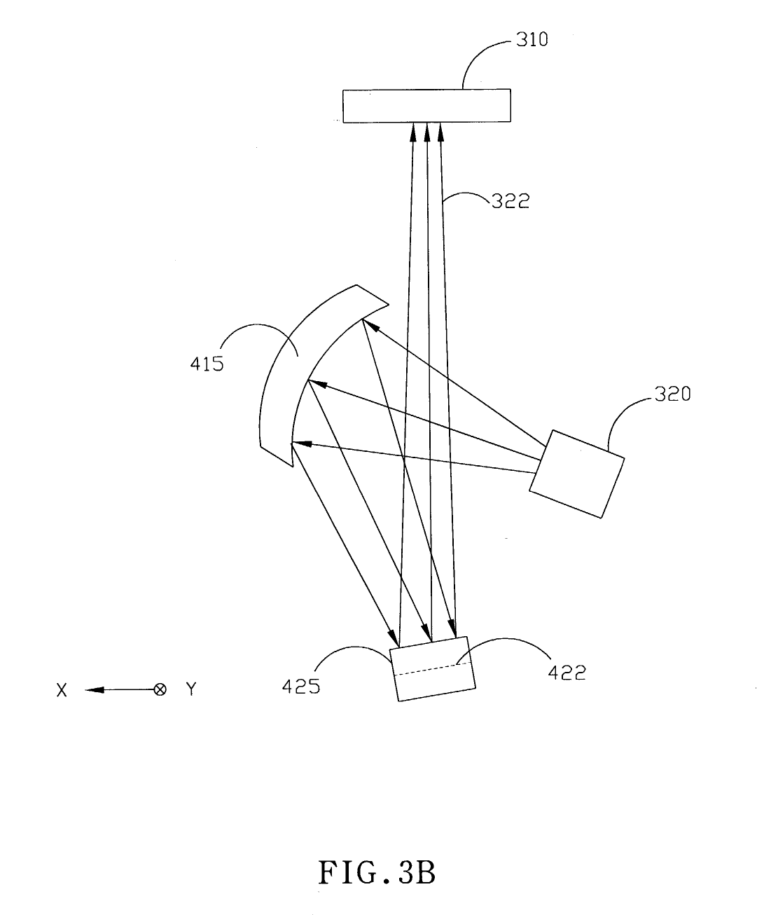

Referring to FIG. 3A, this shows a diagram of the second embodiment of the light source spotlighted device of the present invention. Referring to FIG. 3B, this shows a lateral view diagram of the second embodiment of the light source spotlighted device of the present invention. At first, the present invention provides a light assembly 300, wherein the light assembly 300 can move along the first axial X of a scanning plate 310. A plurality of block luminous bodies 320, such as: light emitting diode (LED), is arranged along the second axial Y of the scanning plate 310 on the base 305 of the light assembly 300, wherein the first axial X and the second axial Y are perpendicular to one another. There is a gap 330 between any two of the block luminous bodies and a length of the gap is decided following needs of processes and products. Then a condensing cover 400 is assembled on the base 305 of the light assembly 300, wherein a material of the condensing cover 400 is a transparent material and comprises the first sidewall 410 and the second sidewall 420. The first sidewall 410 of the condensing cover 400 comprises a concave mirror 415 and the second sidewall 420 of the condensing cover 400 comprises a convex mirror 425 and the edge bottom 422 of the convex mirror 425.

When the plurality of block luminous bodies is drove to shoot light 322, the light 322 will be condensed in the first axial X by using a reflex of the concave mirror 415, which is assembled on the first sidewall 410 of the condensing cover 400, and then the light is reflexed from the concave mirror 415 to the convex mirror 425, which is assembled on the second sidewall 420 of the condensing cover 400 to be disperse uniformly in the second axial Y. The light 322 will be projected on the scanning plate 310 to form a banding shining area by reflexing of the concave mirror 415 and the convex mirror 425, wherein the banding shining area will be moved on the scanning plate 310 following the light assembly 300. Because the light is condensed by reflexing of the concave mirror 415 in the first axial X, a length of the banding shining area showing on the scanning plate 310 in the first axial X will become shorter and the brightness of the banding shining area will become brighter than in the second axial Y to increase the qualities of scanning image. Because the light is dispersed uniformly in the second axial Y by reflexing of the convex mirror 425, the brightness of the banding shining area showing on the scanning plate 310 in the second axial Y will become more uniform and have no dim area defect.

Following description is the second embodiment of the present invention and a scope of the present invention is not limited.

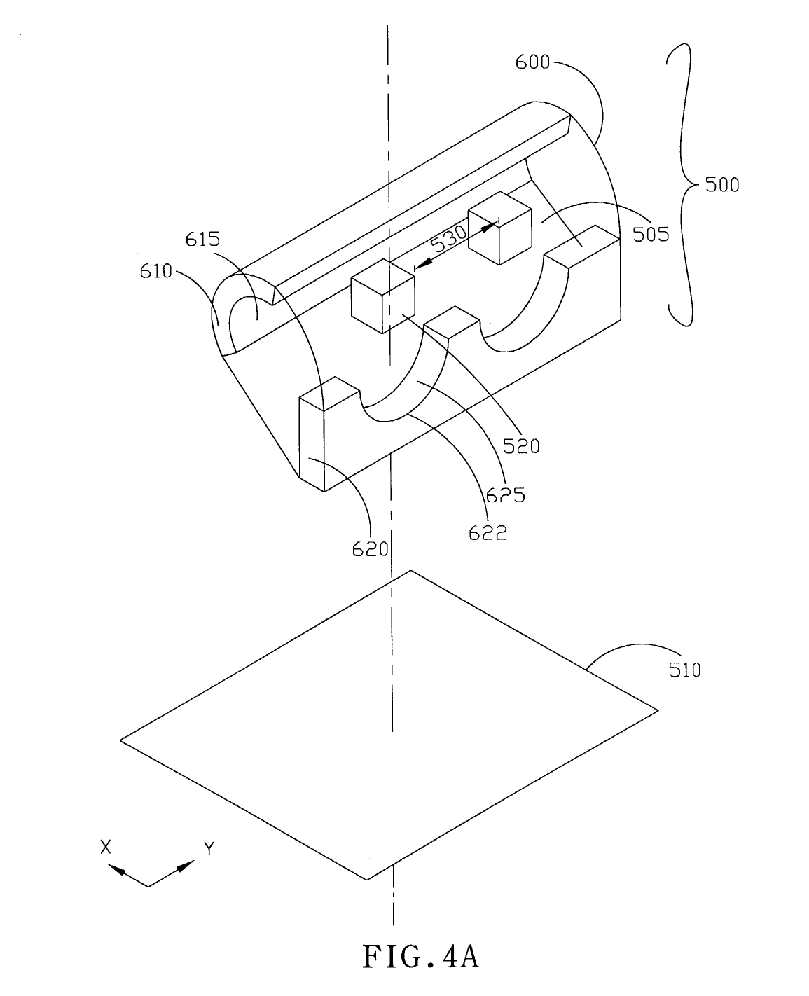

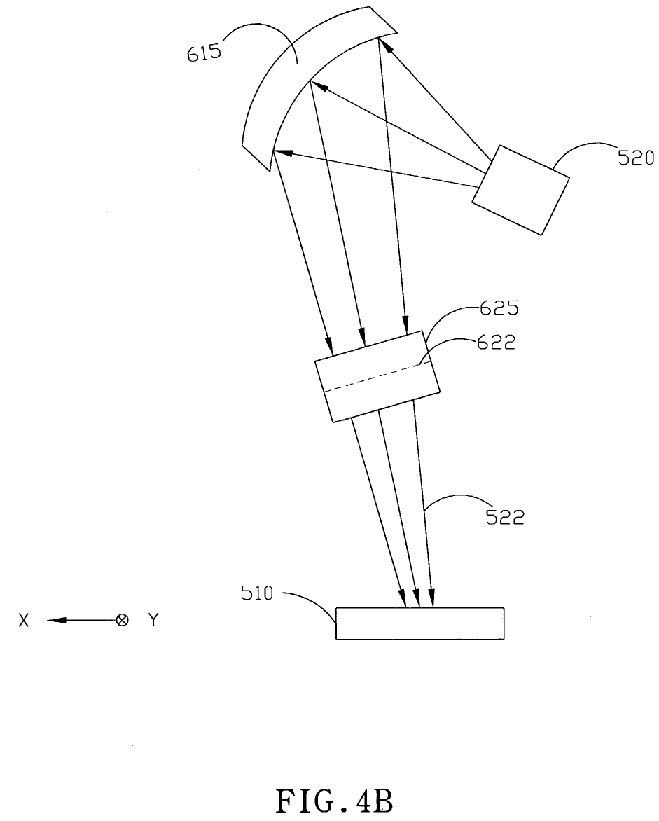

Referring to FIG. 4A, this shows a diagram of the third embodiment of the light source spotlighted device of the present invention. Referring to FIG. 4B, this shows a lateral view diagram of the third embodiment of the light source spotlighted device of the present invention. At first, the present invention provides a light assembly 500, wherein the light assembly 500 can move along the first axial X of a scanning plate 510. A plurality of block luminous bodies 520, such as: light emitting diode (LED), is arranged along the second axial Y of the scanning plate 510 on the base 505 of the light assembly 500, wherein the first axial X and the second axial Y are perpendicular to one another. There is a gap 530 between any two of the block luminous bodies and a length of the gap is decided following needs of processes and products. Then a condensing cover 600 is assembled on the base 505 of the light assembly 500, wherein a material of the condensing cover 600 is a transparent material and comprises the first sidewall 610 and the second sidewall 620. The first sidewall 610 of the condensing cover 600 comprises a concave mirror 615 and the second sidewall 620 of the condensing cover 600 comprises a concave lens 625 and the concave bottom 622 of the convex mirror 625.

When the plurality of block luminous bodies is drove to shoot light 522, the light 522 will be condensed in the first axial X by using a reflex of the concave mirror 615, which is assembled on the first sidewall 610 of the condensing cover 600, and then the light is reflexed form the concave mirror 615 to the concave lens 625, which is assembled on the second sidewall 620 of the condensing cover 600 to be disperse uniformly in the second axial Y. The light 522 will be projected on the scanning plate 510 to form a banding shining area by reflexing of the concave mirror 615 and refracting of the concave lens 625, wherein the banding shining area will be moved on the scanning plate 510 following the light assembly 500. Because the light is condensed by reflexing of the concave mirror 615 in the first axial X, a length of the banding shining area showing on the scanning plate 510 in the first axial X will become shorter and the brightness of the banding shining area will become brighter than in the second axial Y to increase the qualities of scanning image. Because the light is dispersed uniformly in the second axial Y by refracting of the concave lens 625, the brightness of the banding shining area showing on the scanning plate 510 in the second axial Y will become more uniform and have no dim area defect.

In accordance with the present invention, the present invention provides a light source spotlighted device using in the scan device to increase qualities of scanning image by using the light source spotlighted device, which comprises lens components, of the present invention. At first, the present invention provides a light assembly, wherein the light assembly can move along the first axial of a scanning plate. A plurality of block luminous bodies, such as: light emitting diode, is arranged along the second axial of the scanning plate on the base of the light assembly, wherein the first axial and the second axial are perpendicular to one another. There is a gap between any two of the block luminous bodies a length of the gap is decided following needs of processes and products. There are three embodiments of the present invention but a scope of the present invention is not limited. In the first embodiment of the present invention, a condensing cover is divided into the first dispersing structure and the second condensing structure. The first dispersing structure is a part of the condensing cover that is nearer to the base of the light assembly and comprises a plural of concave lenses, wherein each concave lens is corresponding to each block luminous body and is in the third axial of each block luminous body. A material of the condensing cover is a transparent material and a top of the inside second condensing structure comprises a plural of convex lenses. Each convex lens is in the third axial of each block luminous body, wherein the third direction of the third axis is vertical to the first axial and the second axial. When the plurality of block luminous bodies shoots light, the light will be dispersed uniformly in the second axial by using the concave lenses of the first dispersing structure and will be condensed along the first axial by using the convex lenses of the second condensing structure to form a banding shining area, whose brightness is more uniform and have no dim area defect, on the scanning plate. In the second embodiment of the present invention, a condensing cover is assembled on the base of the light assembly at first, wherein a material of the condensing cover is a transparent material and comprises the first sidewall and the second sidewall. The first sidewall of the condensing cover comprises a concave mirror and the second sidewall of the condensing cover comprises a convex mirror. When the plurality of block luminous bodies shoots light, the light will be condensed in the first axial by using a reflex of the concave mirror and then the light is reflexed from the concave mirror to the convex mirror to be disperse uniformly in the second axial. The light will be projected on the scanning plate to form a banding shining area, whose brightness is more uniform and have no dim area defect, by reflexing of the concave mirror and the convex mirror. In the third embodiment of the present invention, a condensing cover is assembled on the base of the light assembly at first, wherein a material of the condensing cover is a transparent material and comprises the first sidewall and the second sidewall. The first sidewall of the condensing cover comprises a concave mirror and the second sidewall of the condensing cover comprises a concave lens. When the plurality of block luminous bodies shoots light, the light will be condensed in the first axial by using a reflex of the concave mirror and then the light is reflexed from the concave mirror to the concave lens to be disperse uniformly in the second axial. The light will be projected on the scanning plate to form a banding shining area, whose brightness is more uniform and have no dim area defect, by reflexing of the concave mirror and refracting of the concave lens. The light source spotlighted device of the present invention can also increase the brightness of the banding shining area of the scanning plate and increase the light uniform level of the banding shining area of the scanning plate.

Although specific embodiments have been illustrated and described, it will be obvious to those skilled in the art that various modifications may be made without departing from what is intended to be limited solely by the appended claims.

What is claimed is:

1. A light source spotlighted device comprises:
a light assembly, being able to move along a first axial of a scanning plate;
a base, locating in said light assembly;
a plurality of block luminous bodies, being arranged along a second axial of said scanning plate on said base to be used to shoot a light to form a banding shining area on said scanning plate, wherein said first axial and said second axial are perpendicular to one another;
a condensing cover, comprising:
a first dispersing structure, comprising a plural of concave lenses to dispense uniformly said light in said second axial and each concave lens is corresponding to each block luminous body in a third axial, said third axial is perpendicular to said first axial and said second axial; and
a second condensing structure, comprising a plural convex lenses to make said light condense in said first axial and to make a brightness of said banding shining area disperse uniformly.

2. The device according to claim 1, wherein a material of said condensing cover is a transparent material.

3. The device according to claim 1, wherein said block luminous body is a light emitting diode.

4. The device according to claim 1, wherein there is a gap between any two of said block luminous bodies.

5. A light source spotlighted device comprises:
a light assembly, being able to move along a first axial of a scanning plate;
a base, locating in said light assembly;
a plurality of block luminous bodies, being arranged along a second axial of said scanning plate on said base to be used to shoot a light to form a banding shining area on said scanning plate, wherein said first axial and said second axial are perpendicular to one another; and
a condensing cover, comprising a first sidewall and a second sidewall, wherein said first sidewall comprises a concave mirror to condense said light in said first axial and said second sidewall comprises a convex mirror to make said light disperse uniformly in said second axial and to make a brightness of said banding shining area disperse uniformly.

6. The device according to claim 5, wherein a material of said condensing cover is a transparent material.

7. The device according to claim 5, wherein said block luminous body is a light emitting diode.

8. The device according to claim 5, wherein there is a gap between any two of said block luminous bodies.

9. A light source spotlighted device comprises:
a light assembly, being able to move along a first axial of a scanning plate;
a base, locating in said light assembly;
a plurality of block luminous bodies, being arranged along a second axial of said scanning plate on said base to be used to shoot a light to form a banding shining area on said scanning plate, wherein said first axial and said second axial are perpendicular to one another; and
a condensing cover, comprising a first sidewall and a second sidewall, wherein said first sidewall comprises a concave mirror to condense said light in said first axial and said second sidewall comprises a concave lens to make said light disperse uniformly in said second axial and to make a brightness of said banding shining area disperse uniformly.

10. The device according to claim 9, wherein a material of said condensing cover is a transparent material.

11. The device according to claim 9, wherein said block luminous body is a light emitting diode.

12. The device according to claim 9, wherein there is a gap between any two of said block luminous bodies.
